(19) United States
(12) Patent Application Publication
(10) Pub. No.: US 2001/0014379 A1
(43) Pub. Date: Aug. 16, 2001

(54) Mold for making a plastic product and a method for making a plastic product by using the mold

(76) Inventors: Takeji Shiokawa, Shiroyama (JP); Mitsuya Mikawa, Isehara (JP); Hideo Kaminaga, Hitachinaka (JP)

Correspondence Address: Mattingly, Stanger & Malur, P.C., 104 East Hume Avenue, Alexandria, VA, 22301, US

(21) Appl. No.: 09/782,302

(22) Filed: Feb. 14, 2001

(30) Foreign Application Priority Data
Feb. 16, 2000 (JP) 2000-037987

(51) Int. Cl. B32B 3/10

(52) U.S. Cl. 428/134; 264/219; 264/328.1; 425/542

(57) ABSTRACT

A mold for making a plastic product according to the present invention comprises a tapered mold and a mold base. The tapered mold having a tapered portion with an outside surface formed in a truncated cone shape and a fixture portion formed at an end on a wide side of the tapered portion. The mold base having at least one hole made therein. The fixture portion is inserted into the hole made in the mold base so that the tapered mold is affixed to the mold base.

### BACKGROUND OF THE INVENTION

The present invention relates to a mold for making a plastic product and a method for making a plastic product by using the mold. It particularly relates to a mold suitable for making a plastic product having a hole for fixing a tapered implant therein and a method for making such a plastic product by using the mold.

Since tapping a hole in a molded plastic product is difficult, it is practiced, when the molded plastic product is to be connected with another member, to embed a nut or the like in the plastic product so that the product is connected with the other member by means of a bolt or the like. As a method for embedding a nut or the like in a plastic product, such a method is used first to set the nut in a mold and then inject molding plastic into the mold. Through such a method, a molded plastic product is formed integral with the nut and thus a plastic product with a nut built therein can be produced.

### SUMMARY OF THE INVENTION

In the method for making a molded plastic product formed integral with a nut, a job to set a nut within a mold must be performed. Therefore, there has been a problem that productivity in the fabrication of the plastic products is deteriorated.

It is an object of the present invention to provide a mold improving productivity in making a plastic product and a method for producing a plastic product by using the mold.

In order to achieve the above mentioned object, the mold for making a plastic product of the present invention comprises a tapered mold having a tapered portion with an outside surface formed in a truncated cone shape and a fixture portion formed at one end on the wide side of the tapered portion and a mold base having at least one hole made therein, in which the fixture portion is inserted in the hole formed in the mold base so that the tapered mold is affixed to the mold base.

In order to achieve the above mentioned object, a method for making a plastic product according to the present invention comprises the steps of preparing a first mold base having at least one hole made therein, preparing a tapered mold having a tapered portion with an outside surface formed in a truncated cone shape and a fixture portion formed at an end on the wide side of the tapered portion, inserting the fixture portion of the tapered mold into the hole made in the mold base, arranging a second mold base so as to touch an end on the narrow side of the tapered portion of the tapered mold, injecting molding plastic into a space formed between the first mold base and the second mold base to thereby form a plastic product, and taking the formed plastic product out of the first mold base, the second mold base, and the tapered mold.

### BRIEF DESCRIPTION OF THE DRAWINGS

FIG. 1 is a partly sectional side view showing a structure of a mold according to an embodiment of the invention.

FIG. 2 is a process chart showing processes for forming a plastic product having a tapered hole made therein by the use of the mold.

FIG. 3 is a sectional view showing a structure of a tapered implant, produced by using a mold, provided with a female thread and to be inserted into a tapered hole.

FIG. 4 is a sectional view showing a structure of a tapered implant, produced by using a mold, provided with a through hole and to be inserted into a tapered hole.

FIG. 5 is a sectional view showing a structure of a tapered implant, produced by using a mold, provided with a bolt and to be inserted into a tapered hole.

FIG. 6 is a partly sectional side view showing a structure of a mold according to a second embodiment of the invention.

FIG. 7 is a process chart showing processes for forming a plastic product having a tapered hole made therein by the use of the mold.

FIG. 8 is a partly sectional side view showing a structure of a mold according to a third embodiment of the invention.

FIG. 9 is a process chart showing processes for forming a plastic product having a tapered hole made therein by the use of the mold.

### DESCRIPTION OF THE PREFERRED EMBODIMENTS

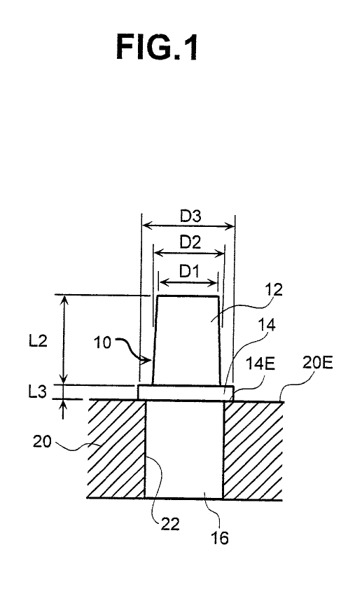

Referring to FIG. 1 to FIG. 5, description will be made of a mold for making a plastic product according to an embodiment of the invention and a method for making a plastic product by using the mold.

First, a structure of a mold for making a plastic product according to the embodiment will be described with reference to FIG. 1.

FIG. 1 is a partly sectional side view showing the structure of the mold according to the embodiment of the invention.

The mold comprises tapered mold 10 made of a tool alloy or the like and mold base 20. The tapered mold 10 has tapered portion 12, projected portion 14 projected from the tapered portion 12, and fixture portion 16. The projected portion, for instance, is a flange portion. The tapered portion 12 has its outside surface formed in a truncated cone shape. When the diameter at the end on the narrow side of the tapered portion 12 is denoted by D1, a diameter D2 of the end on the side where the flange portion 14 is formed is set to be D2>D1. The tapered portion 12 has a taper value, for example, of 1/20. Mentioning a concrete example, the diameter D2 of the end on the side where the flange portion 14 is formed is 9.0 mmφ when the diameter D1 of the tip end is 8.7 mmφ. The flange portion 14 is formed at the end on the wide side of the tapered portion 12 so as to be projected from the tapered portion 12. A diameter D3 of the flange portion 14 is set as D3>D2 and the flange portion 14 is extended in the direction virtually perpendicular to the direction of the central axis of the tapered portion 12. In the case described, the diameter D3 of the flange portion 14 is, for example, 10.0 mmφ. Further, a length L2 of the tapered portion 12 is 11 mm and a thickness L3 of the flange portion 14 is 1 mm. The fixture portion 16 is inserted into hole 22 made in the mold base 20. The fixture portion 16 is used for affixing the tapered mold 10 to the mold base 20. The bottom face of the flange portion 14 is pressed against end face 20E of the mold base 20. Hence, the taper length can be controlled with high precision.

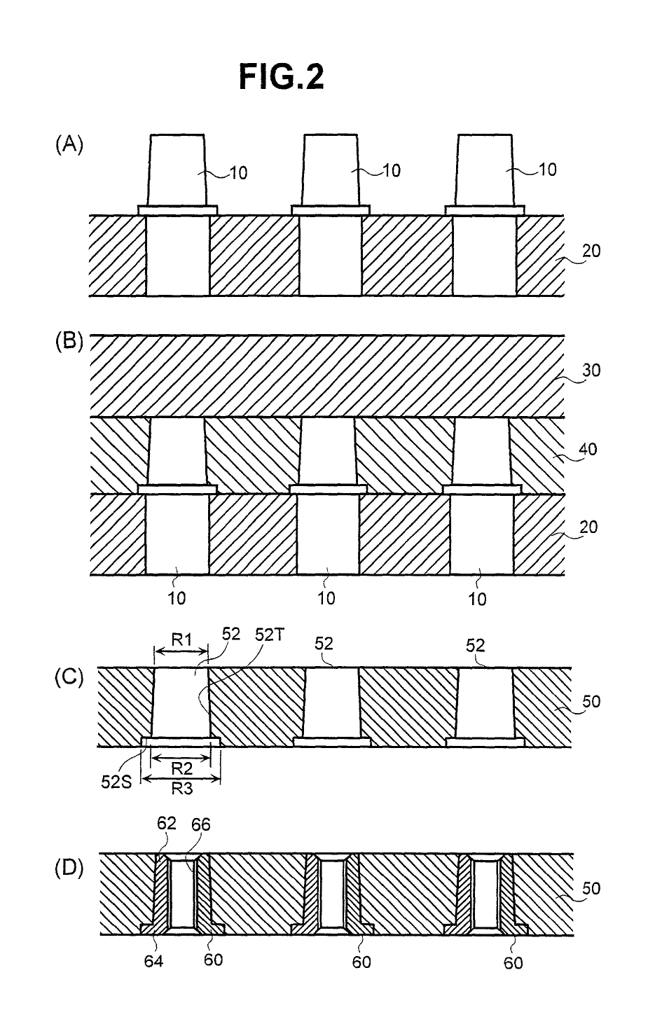

Referring now to FIG. 2, description will be made of a method for forming a plastic product with a tapered hole made therein by using a mold according to the present embodiment.

There are made a plurality of holes 22 in the mold base 20 as shown in FIG. 2(A). Fixture portions 16 of a plurality of tapered molds 10 are inserted into the holes so that the tapered molds 10 are affixed to the mold base 20.

Then, a second mold base 30 is disposed such that the second mold base 30 touches the ends on the narrow side of the tapered portions 12 of the tapered molds 10 as shown in FIG. 2(B). The space formed between the mold base 20 and the second mold base 30 serves as the space into which molding plastic is injected. In the state illustrated, the mold base 20 constitutes the lower mold and the second mold base 30 constitutes the upper mold. Recently, more and more injection molding machines have come to be configured to have two molds on both left and right sides. In such injection molding machines, mold base 20, for example, constitutes the left mold and second mold base 30 constitutes the right mold. Fixture portions 16 of the tapered mold 10 are held in holes 22 made in the mold base 20. Accordingly, even if the mold base 20 is turned 90° from the illustrated state so as to be used as the left mold, such things never occur that the tapered mold 10 falls off or its inserted position is changed. Then, molding plastic 40 is injected into the space formed between the mold base 20 and the second mold base 30 to form a product.

Thereafter, as shown in FIG. 2(C), the second mold base 30 is removed and the molded plastic 40 is taken out from the tapered mold 10 and the mold base 20. The removed molded plastic 40 becomes a plastic product 50 having a plurality of tapered holes 52 into which tapered implants are to be inserted. The tapered hole 52 has s tapered portion 52T and a stepped portion 52S. The stepped portion, for example, is a couterbored portion. A diameter R2 of the tapered portion 52T on the side where the stepped portion 52T is formed (the wide side) is set to be R2>R1 when the diameter of the same at the end on the narrow side is denoted by R1. The tapered portion 52T has a taper value, for example, of 1/20. The stepped portion 52S is formed at the end on the wide side of the taper portion 52T. A diameter R3 of the stepped portion 52S is set to be R3>R2 and the stepped portion 52S is projected in the direction virtually perpendicular to the direction of the central axis of the tapered portion 52T. R1 is virtually equal to D1, R2 is virtually equal to D2, and R3 is virtually equal to D3. Further, since the bottom face 14E of the flange portion 14 is pressed against the end face 20E of the mold base 20 as described in FIG. 1, the total length of the tapered hole 52 thus formed has a distance from the end face of the mold base 20. Therefore, the total length and the length of the tapered portion of the tapered hole 52 can be formed with high precision.

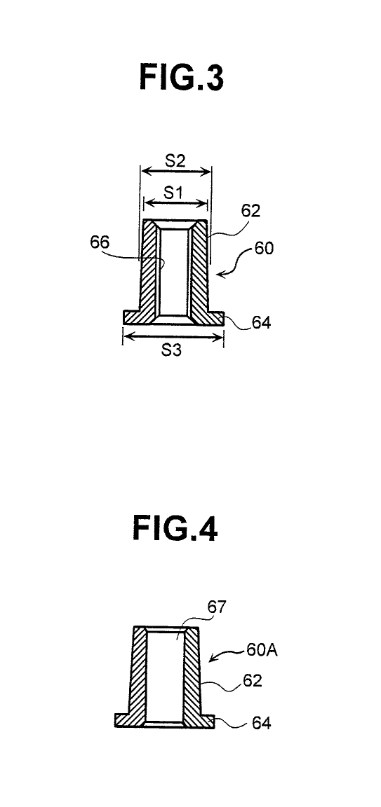

Then, tapered implants 60 are arranged on the side of the stepped portions 52S of the plastic product 50 having tapered holes 52 made therein as shown in FIG. 2(D) and the same are then inserted into the tapered holes 52. The tapered implant 60 has a tapered portion 62 and a flange portion 64. The detailed structure of the tapered implant 60 will be described later with reference to FIG. 3. When the end on the narrow side of the tapered portion 62 of the tapered implant 60 is dropped into the tapered hole 52 in the plastic product 50, the end portion of the tapered portion 62 is brought into its state softly inserted in the tapered hole 52. Then, by applying force F from the side of the flange portion 64 of the tapered implant 60, the tapered implant 60 is inserted into the tapered hole 52 in the plastic product 50 as illustrated. At this time, the surface of the tapered portion of the tapered hole 52 and the surface of the tapered portion 62 of the tapered implant 60 come into contact with each other and the tapered implant 60 is fixed within the tapered hole 52 by friction. The tapered implant 60 has a female thread 66 formed therein.

Structures of tapered implants to be fitted into a tapered hole will be described with reference to FIG. 3 to FIG. 5.

First, a structure of a tapered implant provided with a female thread will be described with reference to FIG. 3.

FIG. 3 is a sectional view showing the structure of a tapered implant provided with a female thread.

The tapered implant 60 provided with a female thread has a tapered portion 62, a flange portion 64, and a female thread 66. The tapered portion 62 has its outside surface formed in a truncated cone shape. When the diameter thereof at the end on the narrow side is denoted by S1, a diameter S2 at the end on the side where the flange portion 64 is formed (the wide side) is set to be S2>S1. The tapered portion 62 has a taper value, for example, of 1/20. Mentioning a concrete example, the diameter S2 of the end on the side where the flange portion 64 is formed is 9.0 mmφ when the diameter S1 of the tip end is 8.7 mmφ. The flange portion 64 is formed at the end on the wide side of the tapered portion 62 so as to be projected from the tapered portion 62. A diameter S3 of the flange portion 64 is set to be S3>S2 and the flange portion 64 is such that is extended in the direction virtually perpendicular to the direction of the central axis of the tapered portion 62. In the described example, the diameter S3 of the flange portion 64, for example, is 10.0 mmφ. Further, when a total length L1 of the tapered implant 60 is 12 mm, for example, a length L2 of the tapered portion 62 is 11 mm and a thickness L3 of the flange portion 64 is 1 mm.

A structure of a tapered implant with a through hole will be described with reference to FIG. 4.

FIG. 4 is a sectional view showing a structure of a tapered implant with a through hole.

A tapered implant with a through hole 60A has a tapered portion 62, a flange portion 64, and a through hole 67. The tapered portion 62 and flange portion 64 are the same as those described in FIG. 3. The through hole 67 is a hole penetrating the tapered implant 60A along its central axis and is provided instead of the female thread 66 in FIG. 3.

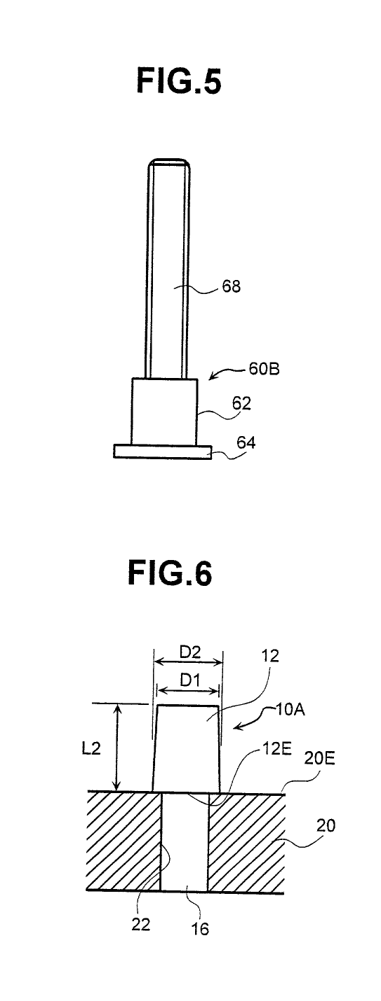

A structure of a tapered implant with a bolt will be described with reference to FIG. 5.

FIG. 5 is a sectional view showing a structure of a tapered implant with a bolt.

A tapered implant with bolt 60B has a tapered portion 62, a flange portion 64, and a bolt portion 68. The tapered portion 62 and flange portion 64 are the same as those described in FIG. 3. The bolt portion 68 is a bolt with a male thread formed on its periphery.

While the tapered implant with female thread 60 was described to be fixed in the plastic product 50 in the example shown in FIG. 2, the tapered implant with through hole 60A or tapered implant with bolt 60B can also be fixed in plastic product 50, as with the tapered implant with female thread 60.

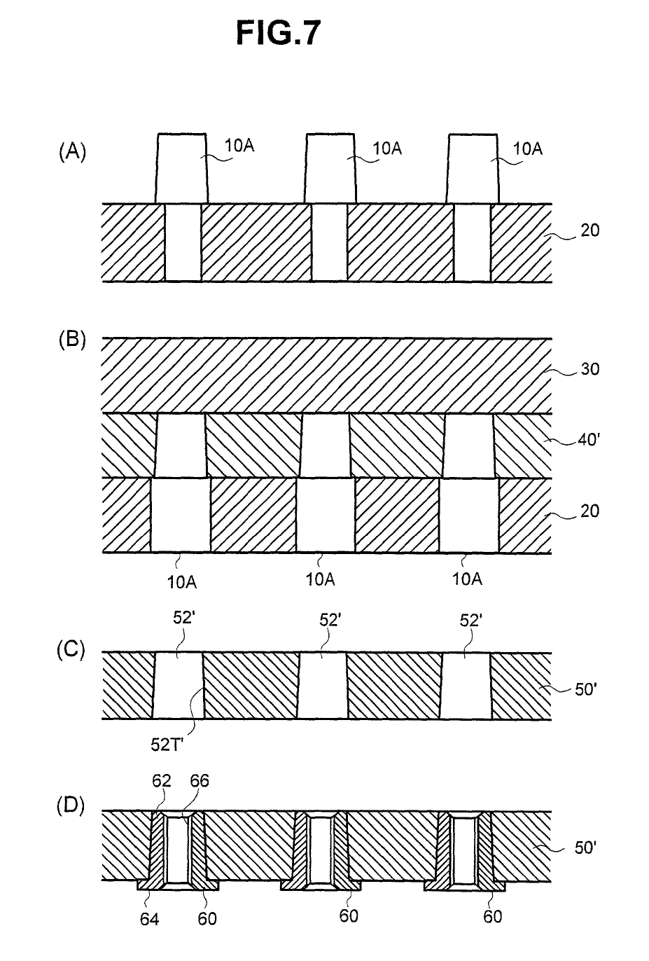

Below will be described a mold for making a plastic product and a method for making a plastic product by using the mold according to a second embodiment of the invention with reference to FIG. 6 and FIG. 7.

First, the structure of the mold will be described with reference to FIG. 6. In the drawing, components structurally the same as those of the mold shown in FIG. 1 are denoted by corresponding reference numerals.

The mold according to the second embodiment comprises a tapered mold 10A and a mold base 20. The tapered mold 10A has a tapered portion 12 and a fixture portion 16. The tapered portion 12 has its outside surface formed in a truncated cone shape. When the diameter thereof at the end on the narrow side thereof is denoted by D1, a diameter D2 at the end on the wide side is set to be D2>D1. The tapered portion 12 has a taper value, for example, of 1/20. Mentioning a concrete example, the diameter D2 of the end on the wide side is 9.0 mmφ when the diameter D1 of the tip end is 8.7 mmφ. In the case described, a length L2 of the tapered portion 12 is 11 mm. Fixture portion 16 is inserted into a hole 22 made in the mold base 20. The fixture portion 16 is used for affixing the tapered mold 10 to the mold base 20. The bottom face 12E of the tapered portion 12 is pressed against an end face 20E of the mold base 20. Hence, the taper length can be controlled with high precision.

A method for making a plastic product with a tapered hole made therein by using the mold according to the second embodiment will be described below with reference to FIG. 7.

There are made a plurality of holes 22 in the mold base 20 as shown in FIG. 7(A). Fixture portions 16 of a plurality of tapered molds 10A are inserted into the holes so that the tapered molds 10A are affixed to the mold base 20.

Then, a second mold base 30 is disposed such that the second mold base 30 touches the ends on the narrow side of the tapered molds 10A as shown in FIG. 7B. The space formed between the mold base 20 and the second mold base 30 serves as the space into which molding plastic is injected. Then, molding plastic 40′ is injected into the space formed between the mold base 20 and the second mold base 30 to form a product.

Thereafter, as shown in FIG. 7(C), the second mold base 30 is removed and the molded plastic 40′ is taken out from the tapered mold 10A and the mold base 20. The removed molded plastic 40′ becomes a plastic product 50′ having a plurality of tapered holes 52′ made therein into which tapered implants are to be inserted. The tapered hole 52′ has a tapered portion 52T′. A diameter R2 of the tapered portion 52T′ on the wide side is set to be R2>R1 when the diameter of the same at the end on the narrow side is denoted by R1. The tapered portion 52T′ has a taper value, for example, of 1/20. R1 is virtually equal to D1 and R2 is virtually equal to D2.

Then, tapered implants 60 are arranged on the wide side of the plastic product 50′ having tapered holes 52′ made therein as shown in FIG. 7(D) and the same are then inserted into the tapered holes 52′. The tapered implant 60 has a tapered portion 62 and a flange portion 64. When the end on the narrow side of the tapered portion 62 of the tapered implant 60 is dropped into the tapered hole 52′ in the plastic product 50, the end portion of the tapered portion 62 is brought into its state softly inserted in the tapered hole 52′ in the plastic product 50. Then, by applying force F from the side of the flange portion 64 of the tapered implant 60, the tapered implant 60 is inserted into the tapered hole 52′ of the plastic product 50 as illustrated. At this time, the surface of the tapered portion of the tapered hole 52′ and the surface of the tapered portion 62 of the tapered implant 60 come into contact with each other and the tapered implant 60 is fixed within the tapered hole 52′ by friction. The tapered implant 60 has a female thread 66 formed therein.

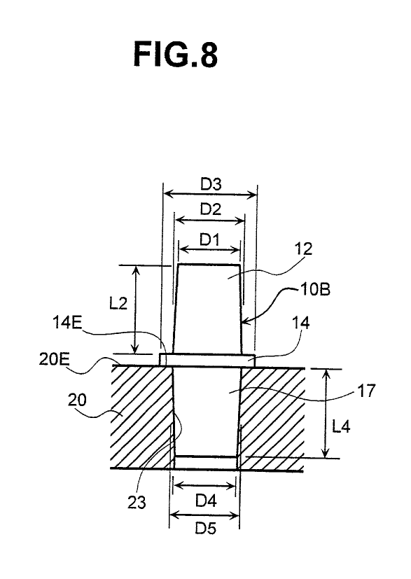

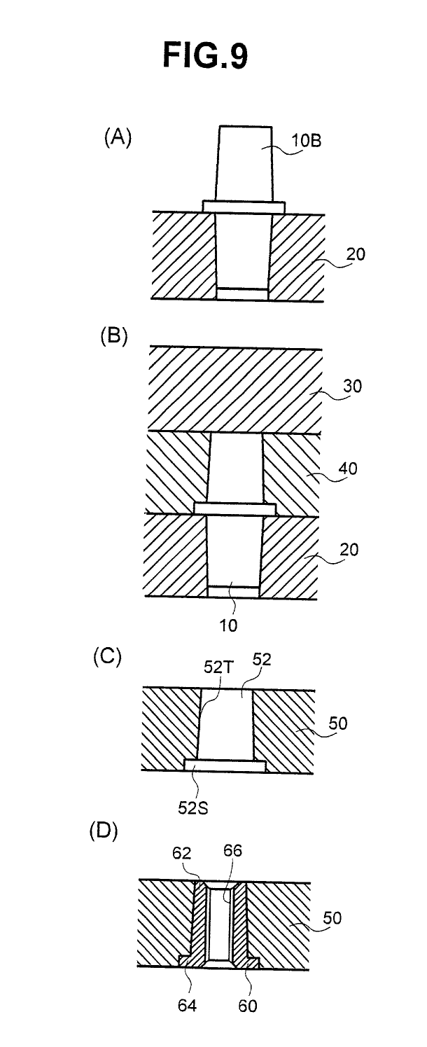

Below will be described a mold for making a plastic product and a method for making a plastic product by using the mold according to a third embodiment of the invention with reference to FIG. 8 and FIG. 9.

First, the structure of the mold according to the third embodiment will be described with reference to FIG. 8. In the drawing, components structurally the same as those of the mold shown in FIG. 1 are denoted by corresponding reference numerals.

The mold according to the third embodiment comprises a double-headed tapered mold 10B and a mold base 20. The double-headed tapered mold 10B has a tapered portion 12, a flange portion 14, and a tapered fixture portion 17. The tapered portion 12 has its outside surface formed in a truncated cone shape. When the diameter at the end on the narrow side thereof is denoted by D1, a diameter D2 at the end thereof where the flange portion 14 is formed (the wide side) is set to be D2>D1. The tapered portion 12 has a taper value, for example, of 1/20. Mentioning a concrete example, the diameter D2 of the end on the side where the flange portion 14 is formed is 9.0 mmφ when the diameter D1 of the tip end is 8.7 mmφ. The flange portion 14 is formed at the end on the wide side of the tapered portion 12 so as to be projected from the tapered portion 12. A diameter D3 of the flange portion 13 is set to be D3>D2 and the flange portion 14 is extended in the direction virtually perpendicular to the central axis of the tapered portion 12. In the case described, the diameter D3 of the tapered portion 14, for example, is 10.0 mmφ. Further, a length L2 of the tapered portion 12 is 11 mm and a thickness L3 of the flange portion 14 is 1 mm.

The tapered fixture portion 17 is inserted into a hole 23 made in the mold base 20. The tapered fixture portion 17 is used for affixing the tapered mold 10B to the mold base 20. The tapered fixture portion 17 has its outside surface formed in a truncated cone shape. When the diameter at the end on the narrow side thereof is denoted by D4, a diameter D5 of the end on the wide side where the flange portion 14 is formed is set to be D5>D4. The tapered fixture portion 17 has a taper value, for example, of 1/20. Mentioning a concrete example, the diameter D5 of the end where the flange portion 14 is formed is 9.0 mmφ when the diameter D4 of the tip end is 8.7 mmφ. Further, a length L4 of the tapered fixture portion 17 is 11 mm. In other words, the tapered portion 12 and the tapered fixture portion 17 have the same dimension. Therefore, the product can be turned upside down so that the tapered portion 12 and the tapered fixture portion 17 may be reversed in their positions. Incidentally, the tapered portion 12 and tapered fixture portion 17 need not necessarily be made equal in size and shape, i.e., they may be made different in size and shape. By forming the fixture portion in a tapered shape, unsteadiness can be reduced when the fixture portion is fixed into the tapered hole 23 made in the mold base 20. Hence, positioning accuracy can be improved. A bottom face 14E of the flange portion 14 is pressed against an end face 20E of the mold base 20. Therefore, the taper length can be controlled with high precision.

A method for making a plastic product with a tapered hole made therein with the use of a mold according to the third embodiment will be described below with reference to FIG. 9.

There are made a plurality of holes 22 in the mold base 20 as shown in FIG. 9(A). Tapered fixture portions 17 of a plurality of double-headed tapered molds 10B are inserted into the holes so that the double-headed tapered molds 10B are affixed to the mold base 20.

Then, second mold base 30 is disposed such that the second mold base 30 touches the ends on the narrow side of the double-headed tapered molds 10B as shown in FIG. 9(B). The space formed between the mold base 20 and the second mold base 30 serves as the space into which molding plastic is injected. Then, molding plastic 40 is injected into the space formed between the mold base 20 and the second mold base 30 to form a product.

Thereafter, as shown in FIG. 9(C), the second mold base 30 is removed and the molded plastic 40 is taken out from the double-headed tapered mold 10B and the mold base 20. The removed molded plastic 40 becomes plastic product 50 having a plurality of tapered holes 52 made therein into which tapered implants are to be inserted. The tapered hole 52 has tapered portion 52T and stepped portion 52S. A diameter R2 of the tapered portion 52T on the side where the stepped portion 52S is formed (the wide side) is set to be R2>R1 when the diameter of the same at the other end is denoted by R1. The tapered portion 52T has a taper value, for example, of 1/20. The stepped portion 52S is formed at the end on the wide side of the tapered portion 52T. A diameter R3 of the stepped portion 52S is set to be R3>R2 and the stepped portion 52S is extended in the direction virtually perpendicular to the central axis of the tapered portion 52T. R1 is virtually equal to D1, R2 is virtually equal to D2, and R3 is virtually equal to D2.

Then, tapered implants 60 are arranged on the wide side of the stepped portions 52S of the plastic product 50 having tapered holes 52 made therein as shown in FIG. 9(D) and the implants 60 are inserted into the tapered holes 52. The tapered implant 60 has a tapered portion 62 and a flange portion 64. When the end on the narrow side of the tapered portion 62 of the tapered implant 60 is dropped into the tapered hole 52 of the plastic product 50, the end portion of the tapered portion 62 is brought into its state softly inserted in the tapered hole 52. Then, by applying force F from the side of the flange portion 64 of the tapered implant 60, the tapered implant 60 is inserted into the tapered hole 52 as illustrated. At this time, the surface of the tapered portion of the tapered hole 52 and the surface of the tapered portion 62 of the tapered implant 60 come into contact with each other and the tapered implant 60 is fixed within the tapered hole 52 by friction. The tapered implant 60 has a female thread 66 made therein.

According to the embodiments described above, since tapered molds are used in making plastic products as described above, the manufacturablity in making plastic products can be enhanced and good productivity can be obtained.

Further, since the tapered molds are easy to replace, reproducibility when tapered molds are inserted can be improved.

Further, since it is only required to insert tapered implants into the holes made in plastic products for connecting the plastic products with other members, workability in connecting the plastic products with other members can also be improved.

What is claimed is:

1. A mold for making a plastic product comprising:
a mold base having at least one hole made therein;
a tapered mold having a tapered portion with an outside surface formed in a truncated cone shape and a fixture portion formed at an end on a wide side of the tapered portion, wherein
the tapered mold is affixed to the mold base by having the fixture portion inserted in the hole in the mold base.

2. The mold for making a plastic product according to claim 1, wherein
the fixture portion is formed in a truncated cone shape, and
the shape of the hole of the mold base is the same as the shape of the fixture portion.

3. The mold for making a plastic product according to claim 1, wherein
the tapered mold further has a projected portion formed at the end on the wide side of the tapered portion so as to be projected from the tapered portion, and
a surface of the projected portion touches a surface of the mold base when the tapered mold is affixed to the mold base.

4. A method for making a plastic product comprising the steps of:
preparing a first mold base having at least one hole made therein;
preparing a tapered mold having a tapered portion with an outside surface formed in a truncated cone shape and a fixture portion formed at an end on a wide side of the tapered portion;
inserting the fixture portion of the tapered mold into the hole made in the mold base;
preparing a second mold base and arranging the second mold base so as to touch an end on a narrow side of the tapered portion of the tapered mold;
injecting molding plastic into a space formed between the first mold base and the second mold base to thereby form a plastic product; and
taking the plastic formed product out of the first mold base, the second mold base, and the tapered mold.

5. The method for making a plastic product according to claim 4, wherein
the step of preparing the tapered mold denotes a step of preparing a tapered mold which further has a projected portion formed at the end on the wide side of the taper portion so as to be projected from the tapered portion.

6. A plastic product manufactured by the process comprising the steps of:
preparing a first mold, the first mold comprising a plate-shaped mold base and a tapered mold, which is projected from a surface of the plate-shaped mold base and has an outside surface formed in a truncated cone shape;
arranging a second mold so as to touch an end of the tapered mold of the first mold;
injecting molding plastic into a space formed between the first mold and the second mold to thereby form a plastic product; and
taking the formed plastic product out of the first mold, the second mold, and the tapered mold.

7. The plastic product according to claim 6, further comprises at least one hole in the same shape as the tapered mold of the first mold, wherein
a tapered implant is inserted into the at least one hole in the plastic product before the same is connected with another member,
the tapered implant having:
a tapered portion having an outside surface formed in a truncated cone shape and contacting the hole;
a projected portion formed at an end adjoining an end portion on a wide side of the tapered portion so as to be projected from the tapered portion and abutting on the plastic product at a periphery of the hole; and
a thread portion provided on the tapered portion.
